(19) United States
(12) Patent Application Publication
(10) Pub. No.: US 2008/0181122 A1
(43) Pub. Date: Jul. 31, 2008

(54) Signaling the Outage of a Network Unit Over a Communications Network

(75) Inventor: Christian Ruppelt, Muenchen (DE)

Correspondence Address: SIEMENS SCHWEIZ AG;I-47, INTELLECTUAL PROPERTY, ALBISRIEDERSTRASSE 245, ZURICH, CH-8047, omitted

(73) Assignee: Nokia Siemens Networks GMBH & Co. KG, Muenchen (DE)

(21) Appl. No.: 11/884,071

(22) PCT Filed: Feb. 9, 2006
(86) PCT No.: PCT/EP06/50792

§ 371 Date: Aug. 9, 2007

(30) Foreign Application Priority Data
Feb. 16, 2005 (DE) 10 2005 007 060.4

(51) Int. Cl. H04L 29/14

(52) U.S. Cl. 370/245

(57) ABSTRACT

In a method for notifying a first network unit of an interruption in a transmission of data of a service on part of at least one second network unit over a communications network, at least one signaling message, which contains at least one parameter concerning a notification during an interruption in the transmission of data of a service on the part of the at least one second network unit, is transmitted by the first network unit to at least one third network unit. In the event of an interruption in the transmission of data of a service on the part of the at least one second network unit, at least one notification message is sent to the first network unit by the at least one third network unit according to the at least one parameter.

Signaling the outage of a network unit over a communications network

The invention relates to a method and device for notifying a first network unit of an interruption in the transmission of data of a service on the part of at least one further network unit over a communications network.

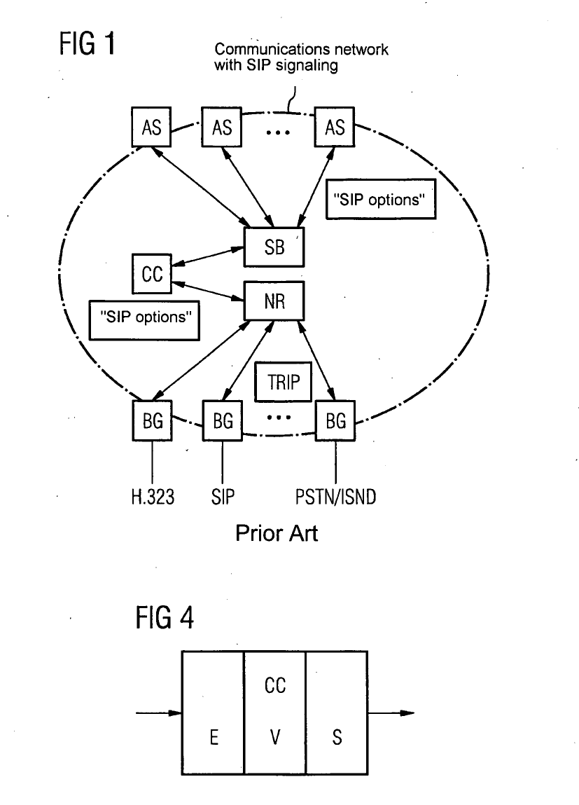

To ensure the outage of the respective network units is identified in the distributed network architecture according to FIG. 1, different already standardized methods, such as for instance the SCTP method (IETF RFC 2960 (Stream Control Transmission Protocol, R. Stewart, Q. Xie: Motorola, K. Morneault, C. Sharp; Cisco, H. Schwarzbauer; Siemens, T. Taylor; Nortel Networks, I. Rytina; Ericsson, M. Kalla; Telcordia, L. Zhang; UCLA, V. Paxson; ACIRI, October 2000) and 3309 (Updates: RFC 2960, Stream Control Transmission Protocol (SCTP) Checksum Change, J. Stone; Stanford, R. Stewart; Cisco Systems, D. Otis; SANlight, September 2002, the SIP OPTIONS methods as “keep alive” (IETF RFC 3261 (RFC 3261, Obsolete: 2543, SIP: Session Initiation Protocol, J. Rosenberg; Dynamicsoft, H. Schulzrinne; Columbia U., G. Camarillo; Ericsson, A. Johnston; World-Com, J. Peterson; Neustar, R. Sparks; Dynamicsoft, M. Handley; ICIR, E. Schooler; AT&T, June 2002)) or TRIP methods (IETF RFC 3219 (RFC 3219, Telephony Routing over IP (TRIP), J. Rosenberg; Dynamicsoft, H. Salama; Cisco Systems, M. Squire; Hatteras Networks, January 2002)), are used.

If the SCTP method is not available or not yet available, the following control mechanisms are necessary for a reliable network:
The central network functionality service broker (SB) must control the availability of the application server (AS). The service broker (SB) decides which application servers (AS) are required and/or are reliable for the service connection or whether the service connection is to be rejected if an application server suffers an outage. In a packet-switched network, such as for instance an IP network with SIP signaling, the SIP method “OPTIONS” is used here as “keep alive”.
The network routing server must control the gateways (border gateways) in respect of an outage, in order either to reject call requests or to report replacement gateways back to a call control unit, such as for instance the call state control function (CSCF) of an IP multimedia subsystem. The TRIP protocol could be used here in accordance with the standard as a suitable protocol.
The central call control unit (call control proxy) must control the service broker and network routing units, in order to activate suitable measures (for instance another routing (rerouting)) in the event that an outage is identified. The standardized “OPTIONS” method for the “keep alive” is also the suitable tool (see FIG. 1).

The call control unit must however likewise be able to identify outages of the non-central network units such as for instance an application server or a gateway (border gateway), since in the event of an outage of a network unit, the call control unit has to trigger calls, release and/or block resources, write CDRs, and set off alarms. In the scenario described above, this information is reliably and meaningfully available in concentrated form in the network units “service broker” and “network routing server” in each instance, however this information can at present not be reliably, rapidly, automatically and consistently exchanged.

The object of the invention thus consists in proposing a possibility for an efficient and cost-effective notification to a network unit in the event that at least one further network unit suffers an outage.

The object is achieved in accordance with the invention by the subject matters of the independent claims. Developments of the invention are specified in the subclaims.

A core of the invention thus consists in a first network unit, for instance a call monitoring unit, notifying at least one second network unit, like for instance network units which exchange signaling messages via the SIP protocol, in other words the gateways (Border Gateways), the application server etc. of at least one third network unit, of the outage and/or the re-availability, in other words the interruption in the transmission of data of a service, the application server etc. over a communications network. In this case, the communications network can be a packet-switching communications network, a cellular mobile radio network, an IP network or a similar communications network. By way of example, the SIP method “SUBCCRIBE/NOTIFY” allows an automated, consistent and real-time notification and/or signaling to be carried out by the monitoring at least one third network unit, such as a service broker network unit, a network routing server etc. to the central call control unit for instance, to the first network unit. The idea here is that the central call control unit in the directly controlling third network unit sets trigger points (dynamically or also persistently) with at least one signaling message containing at least one parameter. In this at least one third network unit, in the event of an outage and/or re-availability being identified in the case of at least one second network unit, these trigger points lead to this outage and/or re-availability, that is the interruption in the transmission of data of a service, being signaling to the first network unit by way of a “SIP NOTIFY” notification for instance.

In this way, the corresponding events with at least one parameter contained in the at least one signaling message are signaled to the at least one third network unit from the first network unit by way of at least one signaling message, an SIP message “SUBCCRIBE” for instance. In the event of an outage and/or re-availability of at least one second network unit, the event is triggered for instance by means of at least one trigger point and the first network unit, for instance the call control unit, is notified about this event by way of SIP message “NOTIFY” for instance. In this way, the events “BE outage”, “BE re-availability” etc. can be used as events for instance.

A significant advantage of the method according to the invention is that the use of the SIP protocol in a communications network, which exclusively uses the SIP protocol, is possible. The proposed solution enables a precise triggering and/or precise charging in the event that the at least second network unit suffers an outage. Such a distributed functionality is required in a “SIP Overlay” communications network. The method according to the invention completes the mechanism for identifying outages in a simple manner and enables central alarm signaling from the first network unit. A standardization of the invention is possible for the SIP SUBCCRIBE/NOTIFY method with suitable definitions of an “event package”.

The invention is described in more detail with reference to an exemplary embodiment illustrated in the figures, in which:

FIG. 1 shows a typical communications network with SIP signaling

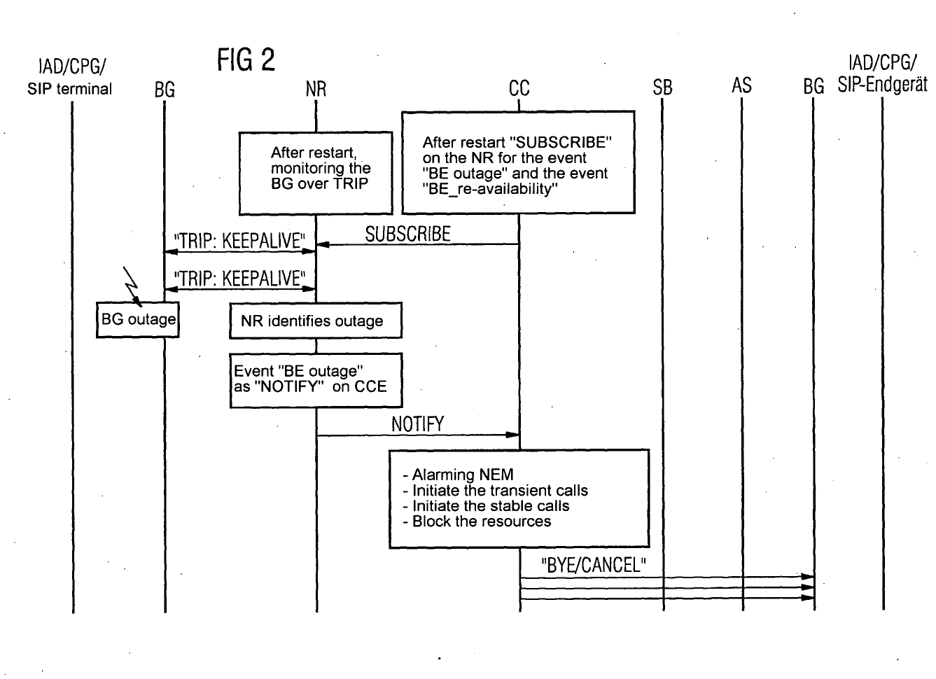

FIG. 2 shows a flow diagram of the method according to the invention in the event of an outage of a gateway

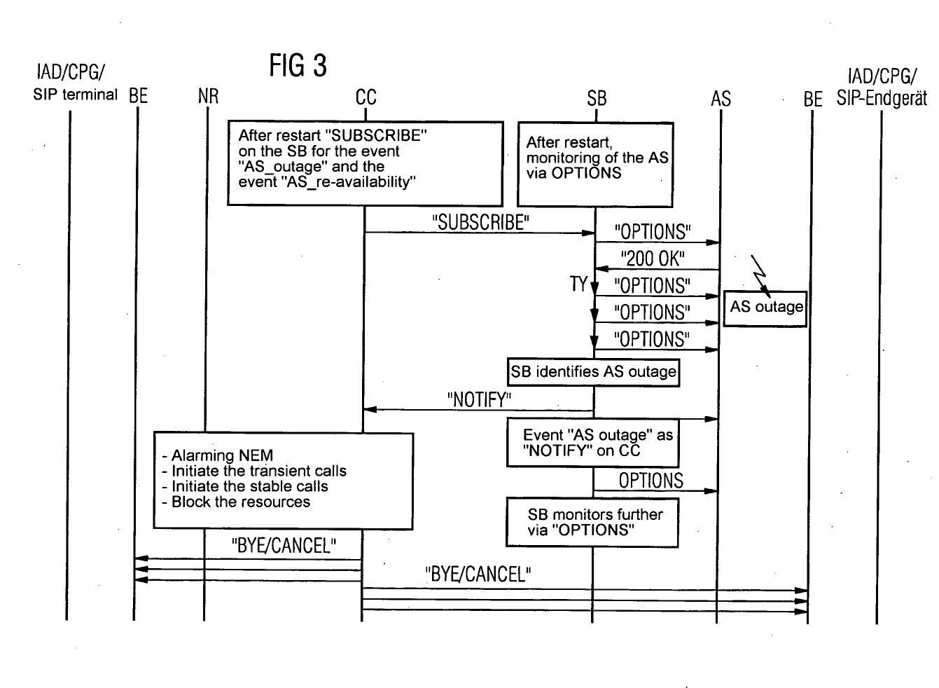

FIG. 3 shows a flow diagram of the method according to the invention in the event of an outage of an application server

FIG. 4 shows an apparatus according to the invention.

FIG. 1 shows a typical communications network with SIP signaling. A so-called SIP overlay communications network is considered with the following distributed functionality:

So-called non-central SIP network units such as for instance gateways BG (SIP Border Gateway) or application server AS;

Gateways BG (SIP Border Gateways): network transition to other/third party communications networks with signaling gateway or NAT function for instance. These network units also perform the subscriber registration.

Application server AS: These servers are responsible for applications. Whether and which application server AS is to be used in a call is decided in the service broker network unit SB. The application servers AS are only activated by the central call control unit CC.

So-called central network units and/or SIP nodes:

Call control unit (Call Control) CC: This network unit is generally referred to as a so-called “stateful SIP proxy” server, and is the central call control entity for instance; all call control messages are routed over the call control unit CC. The call control unit CC can also be responsible for charging and QoS control. In an IP multimedia subsystem such a call control unit CC is also referred to as a call state control function (CSCF).

Service broker network unit SB: This redirect server SB is always incorporated into the connection by the call control unit CC, it (SB) decides which application servers AS are (must/should be) used for the call (and/or the call leg) and conveys this decision as a SIP redirect message for instance back to the call control unit CC, which then activates the application server AS.

Network routing redirect server NR:

This server NR is responsible for finding the respective B-side gateway BG for instance. The call control unit CC carries out a routing to the network routing server NR, following execution of the A-side applications for instance, and said network routing server NR sends the gateway address to the call control unit CC as a SIP redirect message for instance.

The network routing server NR must monitor the gateways GB in respect of an outage and/or an interruption in the transmission of data of a service, in order either to reject call requests or to report replacement gateways BG back to the call control unit CC. Here, the TRIP protocol could be a suitable signaling protocol.

The call control unit CC must monitor the service broker network unit SB and the network routing server NR in order to activate suitable measures (rerouting) in the event of an outage being identified. The standardized SIP OPTIONS method for the “keep alive” is the suitable method here.

FIG. 2 shows a flow diagram of the method according to the invention in the event of an outage of a gateway BG in a communications network, such as for instance a cellular mobile radio network, a packet switching communications network, an IP network etc. A gateway generally forms an interface to other communications networks, such as for instance a fixed network (ISDN, PSTN, etc.) an IP network, an IP multimedia subsystem etc. In this way, the first network unit CC, the at least one second network unit AS, BG and/or the at least one third network unit SB, NR can be network units of an IP multimedia subsystem. Corresponding events with at least one parameter contained in at least one signaling message are signaled to the at least one third network unit NR from the first network unit CC via a signaling message, for instance an SIP message “SUBCCRIBE”. In this way, the parameters can be so-called events, such as for instance the events “BE outage”, “BE re-availability” etc. At least one trigger point (dynamic or also persistent) is set in the at least one third network unit NR, triggered by the at least one signaling message, having the at least one parameter contained therein, transmitted by the first network unit CC. In the event of an outage and/or re-availability being recognized with at least one second network unit BG, here a gateway, in this at least one third network unit NR, these trigger points result in this outage and/or re-availability, in other words the interruption in the transmission of data of a service, being signaled to the first network unit CC for instance by way of a “SIP NOTIFY” message. If an outage and/or re-availability of the at least one second network element BG occurs, the event is triggered for instance by the at least one trigger point and the first network unit CC, for instance the call control unit, is notified about this event by SIP message “NOTIFY” for instance.

FIG. 3 shows a flow diagram of the method according to the invention in the event of an outage of an application server AS. The method according to the invention is used here to signal an outage, in other words the interruption in the transmission of data of a service, of a second network unit AS, here an application server AS, to the first network unit CC. The method is carried out in a similar manner to FIG. 2. The first network unit CC sends at least one signaling message containing at least one parameter to the at least one third network unit SB, here a service broker network unit SB, and at least one trigger point is set in the third network unit SB for instance. The at least one parameter can represent here a “SIP” event, such as for instance the “AS outage” event, the “AS re-availability” event etc. The at least one third network unit NR monitors the at least one second network unit AS, with the “OPTIONS” method for instance, in respect of an outage and notifies the first network unit CC with an SIP NOTIFY message for instance.

FIG. 4 shows an inventive device in a first network unit CC. A processing unit V produces at least one signaling message containing at least one parameter relating to the notification in the event of an interruption in the transmission of data of a service on the part of at least one second network unit AS, BG, and sends said signaling message, according to FIGS. 2 and 3, via a transmitter unit S to at least one third network unit SB, NR. At least one notification message according to the at least one parameter is received using a receiver unit E by the at least one third network unit SB, NR, in the event of an interruption in the transmission of data of a service on the part of the at least one second network unit AS, BG.

1. A method for notifying a first network unit of an interruption in a transmission of data of a service on part of at least one second network unit over a communications network, comprising:
transmitting at least one signaling message, which contains at least one parameter concerning a notification during an interruption in the transmission of data of a service on the part of the at least one second network unit, by the first network unit to at least one third network unit; and
in the event of an interruption in the transmission of data of a service on the part of the at least one second network unit, sending at least one notification message to the first network unit by the at least one third network unit according to the at least one parameter.

2. The method of claim 1, wherein
the first network unit is at least one of a call state network unit and a call state control function.

3. The method of claim 1, wherein
the at least one second network unit is at least one of an application server, a gateway and a proxy server.

4. The method of claim 1, wherein
the at least one third network unit is at least one of a service broker network unit and a network routing server.

5. The method of claim 1, wherein
at least one trigger point is set with the at least one third network unit by means of the at least one signaling message containing at least one parameter.

6. The method of claim 5, wherein
the at least one parameter represents at least one SIP event in at least one signaling message.

7. The method of claim 1, wherein
at least one of the at least one signaling message and the notification message is a message according to the SIP protocol.

8. The method of claim 1, wherein
at least one of the at least one signaling message and the notification message is a message according to a TRIP protocol.

9. The method of claim 8, wherein
at least one signaling message according to the TRIP protocol is exchanged between the at least one third network unit and the at least one second network unit.

10. The method of claim 1, wherein
at least one of the first network unit, the at least one second network unit and the at least one third network unit is a network unit of an IP multimedia subsystem.

11. The method of claim 1, wherein
the communications network is at least one of a packet-switching communications network, a cellular mobile radio network and an IP network.

12. A device for notifying a first network unit of an interruption in a transmission of data of a service on part of at least one second network unit over a communications network, comprising:
a processing unit for producing at least one signaling message, which contains at least one parameter concerning a notification during an interruption in the transmission of data of a service on the part of the at least one second network unit;
a transmitter unit for sending the produced signaling message to at least one third network unit; and
a receiver unit for receiving at least one notification message according to the at least one parameter from the at least one third network unit during an interruption in the transmission of data of a service on the part of the at least one second network unit.
